(19) United States
(12) Patent Application Publication
(10) Pub. No.: US 2012/0279405 A1
(43) Pub. Date: Nov. 8, 2012

(54) Pokeroot ink pamphlet press

(76) Inventor: Dena Kaye Berg, Arkansas City, KS (US)

(21) Appl. No.: 13/067,058

(22) Filed: May 4, 2011

(51) Int. Cl. B41K 1/42

(52) U.S. Cl. 101/333

(57) ABSTRACT

This invention will ink and print any craft stamp and align the paper with the stamp, so that you do not have to manually align the paper and stamp the stamp, regulating the pressure, placing it so that it is able to dry before it is disturbed. Because it will print stamps made by the stampmaker, it may act as a press. It can utilize homegrown ink.

A dense spiraled stamp pad is continuously inked as the rotating ink cam above it leaks ink out of its several holes onto the underlying ink pad. The ink cam is wrapped with as sponge drawing and spreading the ink onto the underlying stamp pad.

The stamp pad in turn inks the underlying stamp cam, which is a PCV pipe with a stamp glued onto it.

As it turns, it inks the continuous roll of paper which is being pulled through the stamp cam, and the acrylic frame, which provides a giveable support for the paper as the stamping cam prints on it.

### BACKGROUND OF THE INVENTION

I am a born again Christian. The Bible says that there will be a certain event known as the rapture, when born again Christians will be taken to heaven as Christ returns to take them away. There will then be a time of peril upon the earth known commonly as the tribulation period. During this time, the AntiChrist will rule, and claim to be the Christ. You will not be able to buy or sell without the number of the beast which is 666. The gospel will be greatly hindered. Anyone giving out the gospel will be beheaded, and those who trust Christ as their Savior will not be able to buy tracts or have them printed in any way. There will no way to give out the gospel anonymously, and yet many, in times of peril, will be seeking the Lord.

With the technology available today, it seems a little unreal that individuals do not have some form of unmonitored manual printing press available for home use, other than the computer. I wanted to invent a press which could be made cheaply from readily available resources, which could avail the use of free ink, or homegrown ink, wherein the government could never hinder or minitor the production of the press.

With a new scrapbooking tool called the stampmaker, (which will allow us to produce our own stamps, and even design our own texts,) this invention literally becomes a press.

In times of peril, and tyranny, unmonitored, unlicensed, uncensored, and undetectable printing presses should be in every home. In the dark ages, reading and writing were illegal. Without presses, people could not conspire anonymously or amass a gathering against tyrannical rulers. People were prohibited from giving the gospel out in any way.

Unbeknownst to many, Martin Luther had the Guttenberg printing press, and probably safely availed the use of this tool, by passing out anonymous tracts, asking people to meet at the church at a certain time of day, where they would then see his 96 thesis with his signature nailed to the door.

A press is a necessary tool for freedom because it allows us to conspire anonymously, and to amass gatherings, and to present ideas where the author cannot be witnessed against.

Anyone speaking one on one and face to face, that which is illegal, has because of a witness, the potential of being arrested or seized.

Our forefathers gave us the right to assemble and the right to a free press, but only an unmonitored press can guarantee this right. It is important to note that when they spoke of a free press, they were not speaking about the right of the mass media to present unpopular ideas, for no such entity existed.

If the government were to prohibit the production of presses, or license them, as they have done in the past, there is no apparatus I know of, which would allow us to freely print the gospel, or anonymously gather a crowd. The computer has the potential of being highly monitored. Quick print shops could be prohibited from availing the printing of any unlicensed material, and even public copy machines, and office copy machines are easily monitored and locked.

It has occurred to me that in a state where printing presses were illegal that companies would not be allowed to produce them, and the only way people could avail the use of a press would be to produce their own. It is also possible, that even today, if a company were to get a patent on said press, a larger company, such as IBM which sold ink and presses (for the computer is a press) could conceivably buy them out, leaving such an invention dead in the water.

For this reason I wanted to invent a simple press which could be made cheaply by individuals from readily available resources, and which could utilize free ink which did not have to be purchased.

Though the utilization of molds could make this same design a more expedient model, in that the cams could be made to be of a more lightweight material, and the rods could be made to be more durable, and to fit easier and more adjunctly into designed crevices, this model does not necessitate the pouring of molds, and the prototype itself could be manufactured by individuals.

Every piece used to make this press could be easily and cheaply purchased from craft stores and hardware shops.

With this press, you could print your own tracts indefinitely, (after once designed,) and they could never be easily hindered or monitored. This press utilizes pokeroot ink, which grows freely in every country of the world, I am told. Homegrown ink does not need to be purchased, and continually relinquishes itself. (It makes a watery print by itself, and prints best with a little flux and glycerin, but would suffice to print alone, in times of an emergency, if a very dense pad is used, and the ink is brayered deep into the pad.)

Because individuals can make this press fairly easily, it is constantly repairable and maintainable, availing its own lifetime guarantee.

Because individuals can make these themselves, it also gives a certain amount of accountability to those in the future who will manufacture and modify future versions of this, keeping the cost down to the public, as there will always be a certain degree of competition.

In third world countries, such as Africa, this press could be utilized by missionarys, where electricity is not available, and where they cannot easily run into town to buy supplies.

This machine can utilize any ink, and does not need specially designed and expensive ink cams, which must be purchased from companies which must figure the designing and pouring of molds into their costs, as they have especially designed their own ink cams and stamp pads for their own presses.

The stamp cams can be easily cut from PCV pipe, costing only 0.10 to 0.15 cents apiece, making them cheaper and more available to the public, than stamp cams made from companies which had to pour molds and figure them into the costs. Any stamp can be utilized, as the stamp is simply glued onto each separate cam. This of course, commits the stamp to be used as a rolling stamp, but allows the creative individual a much greater versatility in designing his/her own stamps. It would allow handicapped individuals to make this press, or other individuals to manufacture this from their home. This is my intention also.

I intend to publish the directions to make this press in a popular craft magazine, which will refer them to a blog, where I can show them more specifically how to make this, and weekly publish scrapbooking ideas and ways to use it. I will keep a list of those who want to make them, and a list of those who want to order them. When there are enough orders, we will be able to mass produce them, as there is a need.

I have already asked a popular magazine to publish the directions for this press and the ink, but they cannot do that safely without at least a patent pending.

I use this device to make handscrapped tracts, and people love them. I have included several of these tracts with this patent application, because I believe it shows the scope and the possibilities of the invention. I realize the tracts will be discarded, and I have not yet created one with a text using the pamphlet press, but it shows the scope of the invention.

I realize my model will soon be modified and made obsolete, as I am not capable of competing with engineers, but even though this model is somewhat primitive, I believe it serves a purpose. The simplicity is actually what makes it desirable. It does not need modern technology to perform, but can print from crude elements indefinitely, (after you purchase or design your stamps.)

Those of us who know Christ and believe the Bible know that such a time will certainly exist, and that there is a need for such an invention.

Ink Recipe: Pokeroot is a perennial weed, and grows larger each year. The mature plant usually yields 2 pints of ink. Pokeroot may even take over a field, and needs no care or watering if planted in the shade. Crush the berries, and mix the ink with a little flux. It has to be soaked or brayered into the pad, so it is best to prime the rollers first. Add a little glycerin to the pad. There is an extra roller on the press which presses it into the pad.

If you pick pokeroot at the beginning of the season, it will give you a beautiful magenta ink. Towards the end of the season, it tends towards purple. If you mix it with vinegar, it turns red. As it ages, it turns to rust and then to brown. Baking soda and alcohol have turned it to green, (though this color is not always reliable.) Canning it with cream of tartar turns it to a salmon. Ammonia tends towards purple. Diluting these colors with water will give you pastel pinks, peaches, and lilacs. Though this method cannot be used with the press, freezing the ink in a large flat surfaced container, and placing a raised pad in the ink (raised just above the ink) will give you a beautiful print.

Stamp the flat surface of the iced ink, and then stamp the stamp on the pad. The ink is glossy and looks almost embossed this way. I believe this ink will catch on. I have literally had a freezer full of it.

This formula was published by Heartland Bible Baptist College in May of 2008.

I have contacted numerous nurseries and asked them to begin growing pokeroot.

### BRIEF SUMMARY OF THE INVENTION

This invention will ink and print any commercial craft stamp and align the paper with the stamp, so that you do not have to manually align the paper and stamp the stamp, placing it so that is able to dry before it is disturbed. A recent invention, called the Stampmaker, which retails for $150.00, will allow you to make and design your own clear stamps, making this a new and needed device. It inks the stamp and regulates the pressure of the stamp so that the stamp does not misprint, and you do not have to concentrate on pressing every area of the stamp, to make sure every part is inked.

It also can utilize pokeroot ink, (my recipe) which is almost free, and can produce, with the aid of some simple household chemicals numerous beautiful colors: (Though this is not the subject of this patent, pokeroot can be made to produce a beautiful magenta, salmon, red, pink, rust, purple, or green ink, for a fraction of the cost of commercial inks.)

The pamphlet press pulls a continuous roll of paper through the inked stamp, thus aligning the stamp, and placing a mark showing you where to cut the individual sheets. As the paper stays on the roll, and gradually slides to the floor, it also gives the ink drying time, whereas if you are manually inking stamps, you must place them individually in areas to dry, within arms reach, stopping periodically to gather them up and stack them. It can also utilize any stamp on the market, including clear polymer stamps, rubber stamps, or cling stamps allowing the craft stamper to utilize his favorite stamps, and even design text, and printed pamphlets.

The ink recipe is included in the BACKGROUND OF THE INVENTION, and will be published by a popular stamp magazine, when I can provide a patent pending for the pamphlet press, as will the ink recipe.

### BRIEF DESCRIPTION OF THE SEVERAL VIEWS OF THE DRAWINGS

FIG. 1 represents the front view of the apparatus as the top roller rotates, and inks the underlying stamp pad. As the ink leaks out of the holes in the inking cam, it is spread onto the underlying stamp pad, so that the stamp pad is continually reinked. The pad then inks the underlying stamp cam as it is pressed against the stamp pad. The stamp cam presses against an acrylic picture frame, which serves as support for the paper which is being pulled between the acrylic frame and stamp cam.

FIG. 2 is an exploded exposed side view of the cams working and resting against the acrylic frame which has been slid under the stamp cam, until it touches the cam at all points, and provides support and a somewhat giveable surface, for the paper which travels between the stamp cam and the acrylic frame, where it is stamped by the cam.

FIG. 3 is a pattern needed for the xyloprene or very dense foam stamp pad. The xyloprene should be placed on the exposed double stick adhesive, and the pattern placed on top. Use a craft knife and cut the xyloprene (or very dense foam pad) according to the pattern. It must be cut on the bias and spiraled onto the roller. It cannot simply be rolled onto the roller, or there will be a seam, which will eventually bunch up as it is pressed forward continually with the rollers.

FIG. 4 is a pattern piece which, when fitted around metal holes which protrude from the sides of the press will pinpoint exactly where the hole in the side of the press is to be drilled. The holes will support the rod that the stamp cam turns on.

FIG. 5 is a picture of a 4″ by 6″ acrylic frame and shows how the underside of the frame is turned under to hold the photograph in place. (These pieces are cut off and turned sideways to be used as a paper guides.)

FIG. 6 shows two ends of the acrylic frame which have been cut off and turned on their sides, and glued to both ends of the main acrylic frame to be used as paper guides, to keep the paper from slipping out of place.

FIG. 7 shows a stamp cam which could be manufactured of a more lightweight constitution, with the border stamps 44 and rod 45 already in place.

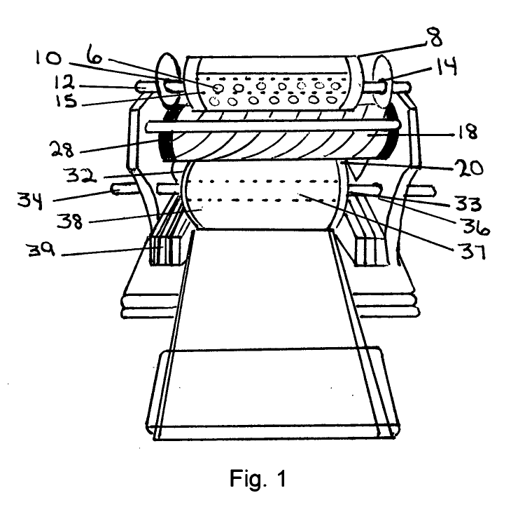

### REFERENCE NUMBERS USED IN THE DRAWINGS AND DESCRIPTIONS

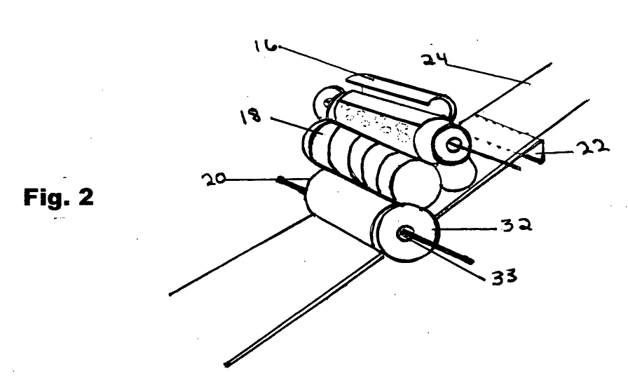

8 Inking Cam 4″ length of 1¾″ dia. PCV pipe or lightweight tubing of the same dimensions
6. ⅛″ holes drilled into cam (or PCV pipe)
10 Knock Out Seals which serve to seal the inking cam, and support the rod that the inking cam turns on.
12 a 7″ Piece of ⅛″ Wire or Rod which is threaded through both ends of the cam and secured in the holes in the fender washers to support the cam as it rolls.
14 3/16″ BY 1½″ Fender Washers are welded to each side of the press so that the holes support the wire the cam turns on.
15 Tubing It is easier to thread the cam if there is a tubing in the middle, so that you do not have to feel with the wire for the hole.
16 3″ by 4″ Porous Sponge wrapped around the inking cam which serves to draw the ink out of the cam and spread it onto the pad below. (See FIG. 2)
18 The dense inking pad is cut into strips and spiraled onto the roller, so that it does not bunch up, and so that no seam exists.
20 The Stamp Cam is a 4″ length of 1¾″ dia. PCV pipe or lightweight tubing of the same dimensions.
22 4″ by 6″ Acrylic Frame which rests on its back, and supports the paper as it is angled up against the stamp cam.
24 Paper which glides under the stamp cam to be stamped
28 shows that the ends of the pad are cut away from the sides of the rollers so ink does not eventually gum up the rollers.
32 End Caps for 1¾″ Dia. PCV Pipe have a hole which supports the rod or wire that the stamping cam turns on
33 ⅛″ Hole
34 7″ of ⅛″ round wire or rod, which supports stamp cam, and is inserted into two holes which have been drilled into the sides of the press to support the wire.
36 Pattern to show where to drill the two holes in the sides of the press
37 Tubing which serves to direct the wire through the holes in the stamping cam easier
38 Stamp which has been superglued onto the stamp cam
39 Shims inserted so that the stamp cam cannot wobble. Different sized stamp cams could be used if shims are used. Stamp Essentials makes a stamp cam with a manual handle, which will fit to the pad and stamp, but it is shorter and needs the cams to support it.
42 Cut Off Ends of 4″ by 6″ acrylic frames, which are placed on both ends of the main acrylic frame to act as paper guides, and keep the paper from slipping from side to side.
43 shows the placement of the cut off end pieces which have been glued onto the main acrylic frame
44 border stamps
45 center rod

### DETAILED DESCRIPTION OF THE INVENTION

Ink is injected into one of the holes drilled in the ink cam 6 by means of a large syringe. As you turn the handle the ink cam 8 rotates, leaking ink out of the two lines of ⅛″ holes 6 which have been drilled into both sides of the 4″ length of 1¼″ pcv pipe, or tubing 8 The pipe has 2¾″ dia. knock out seals or caps 10 which seal the ends of the inking cam, and a hole in the center of these seals, accommodates a 7″ length piece of ⅛″ dia. wire, or rod 12 which is threaded through the cam, and into the holes of 2 3/16″×1½″ fender washers 14 which have been secured to the sides of the press (either by welding or superglue) so that the holes in the fender washers are plush with the top of the press, and support the wire.

(Tubing could be placed through the holes first, providing a tunnel for the wire to go through, making it easier to thread the wire through the cam.) 15

The ink cam is wrapped tightly with a 3″ by 4″ piece of very thin and porous sponge, (much the consistency of the sponges used to wrap the hair rollers used for hair permanents.) 16 See FIG. 2

This sponge is glued onto the cam and covers the holes, and serves to draw the ink out of the cam and spread it onto the ¼″ dense foam ink pad 18 inking the pad as it turns.

The foam inkpad 18 rotates and inks the underlying stamp cam. 20 The stamp cam rests on an angled acrylic picture frame 22, (See FIG. 2) which has been laid on its back, and the angled surface is pressed under the ink cam until it touches the stamp. This provides a stampable and somewhat giveable surface for the paper 24 as it is gradually being pulled through and stamped, and travels between the acrylic frame 22 and the stamp cam 20

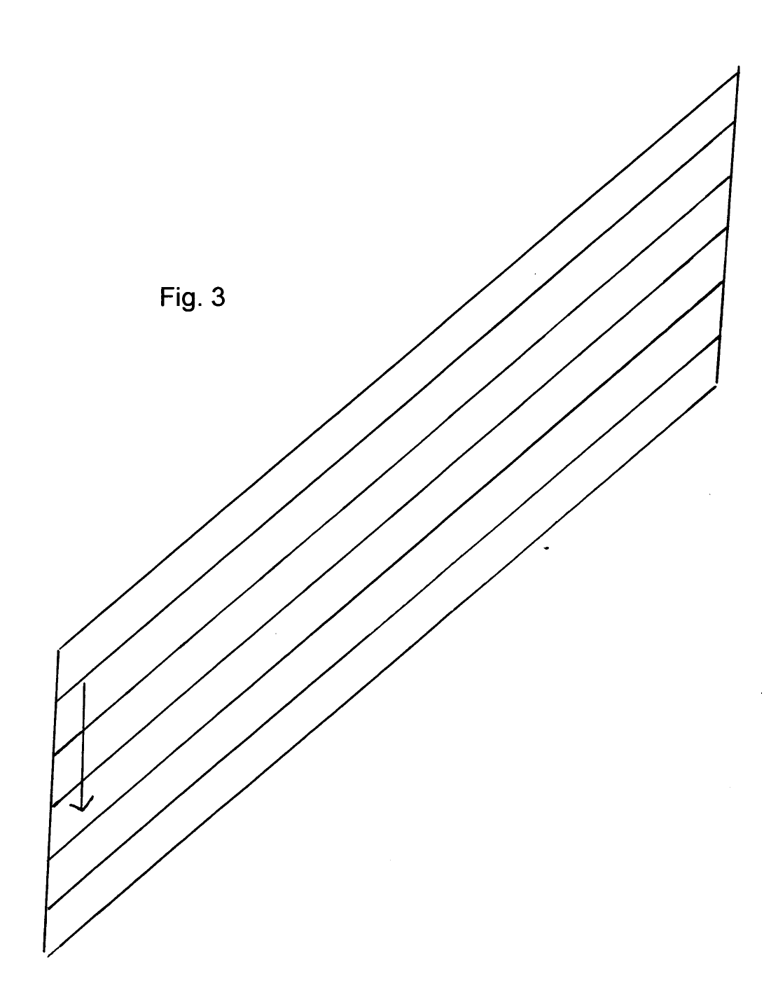

The pad was hitherto adhered to a piece of doublesided adhesive, and cut into bias strips using the aid of the pattern piece—FIG. 3. and a craft knife. The arrows on the patterns were placed on the straight side of the foam, and the strips cut with a craft knife, not cutting through the adhesive. The backing of the adhesive was then removed, and the strips (still clinging to the adhesive) were spiraled around the main roller—(the one which is connected to the handle.)

The straight edge of the pad, (marked on the pattern with an arrow) was lined up with the end of the main roller. As the pad was brought around again, it was aligned right next to the first piece until it was spiraled around the entire roller. The ends, at this point should be cut in at least an inch from the edge of the roller with a craft knife. 28 The pad does not need to be longer than the underlying stamp cam, and ink, from the stamp pad tends to leak into the rollers clogging them and hindering the free movement of the rollers if you place the pad plush with the edge.

The ends of the strips can be glued down with E600 glue or tied with nylon tape for extra longevity, but at this point the strips can be replaced one at a time if they wear out.

The xyloprene or foam is so dense that it presents a bit of a problem, in that the ink will not saturate the pad, and tends to sit on top, making a watery print. The density of the pad is necessary for a better print. The thinner porous pad will squeeze through the rollers easier, but will leave minute areas of the stamp uninked.

The thicker pad will squeeze through the rollers, and the ink will be pushed deep into the pad where the stamp will have to grab it, and it will produce a better print.

The pressure on the pad however, also presents a problem, in that the pressure on the rollers, tends to push it forward, stretching it, causing the pad to bunch up. It therefore must be stretched very taut before gluing it in place. This will often either rip the pad, or cause the glue not to hold it sufficiently due to the stress on the pad. At best, it is very cumbersome for you must hold the pad in place until it dries, or remove the rods from the mechanism to replace the pads.

This is easily rectified by spiraling the pad onto the roller. The spiraling of the ⅜″ strips seem to give it a little bit of give. 18 It also rectifies problem of a seam, which tends to bunch, and come up easily. The seam also never matches exactly, and leaves an uninked area.

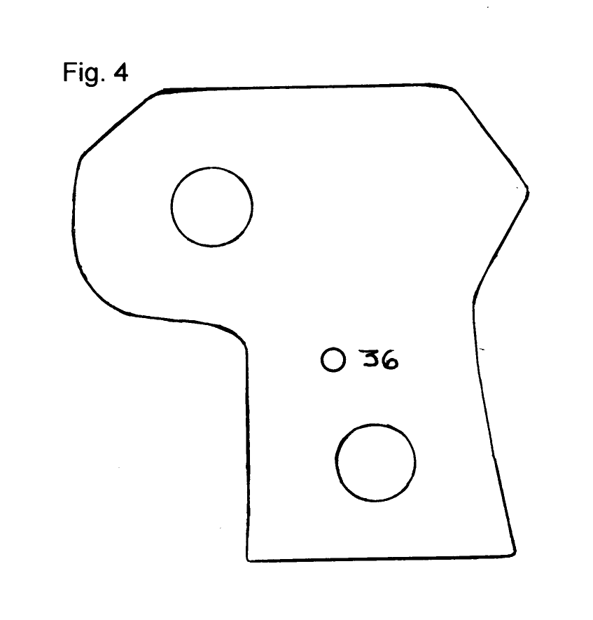

The inked pad rotates and presses against the underlying stamp cam. 20 The stamp cam is a 4″ length of 1¾″ dia. PCV pipe, or tubing 20 which has had the 1¾″ end caps 32 glued into the ends. A ⅛″ inch hole has been drilled into both caps 33 to accommodate a 7″ length of ⅛″ wire or rod, 34 which is threaded through the cam, and then slipped into holes drilled (with the aid of the pattern FIG. 4) into the sides of the press.

Again, (tubing slipped through the holes will serve to direct the wire to the Hole, making it easier to thread. 37

The exact spot where the hole is to be drilled in the pasta press can be found by removing the sides of the press, (prying them off with a screwdriver.) Cut out the pattern FIG. 4, and cut the holes out of the pattern with scissors, and then place the holes around the holes that protrude on the sides of the press. Fit the pattern into place, securing it around the holes, and then drill a ⅛″ hole in each side of the press where the pattern is marked. 36 This must be very precise. If the hole is not drilled in the exact spot as marked, the stamp cam will either be too tight against the pad and will not roll, or not be firm enough against the pad to get inked, and stamp unevenly.

The stamp 38 has been superglued onto the cam; thus you may use any stamp. The stamp is now committed to being a roller stamp, but the cams only cost between 0.10 and 0.15 cents.

Shims 39 are placed between the stamp cam and the sides of the press to keep it from from wobbling or printing unevenly. Different sized stamp cams can be used because of this. In fact, the Memory Essential rolling stamp wheel can be removed from its manual handle, and used if you do not wish to utilize or make your own stamp cam.

There must be a continuous design on the stamp. If there is an area of the stamp cam which is recessed (because there is no raised stamp image) the stamp cam will not catch the pad, and will cease to turn.

Thus, if you are printing simple designs, with many open spaces, you must utilize a border stamp to decorate the edges, so the stamp will continue at all points to reach the stamp pad. The raised image of the stamp pressing against the pad is what causes the stamp to turn. stamp pressing against the pad, is what causes the stamp cam to turn. (If these cams were manufactured, the stamp cams would have to have continuous borders on both ends of the cams to necessitate a constant turn. If I did manufacture this cam, I would also place rolls of adhesive in the center so that people could affix their own stamps to the center. (See FIG. 7.)

I usually place a line stamp where the seams of the stamp meet, or use the seam as a marker for cutting the paper. One entire rotation of the cam will mark the paper every 5½″.

The exploded view FIG. 2. is an exposed view of the rollers working. (The 4″ by 6″ acrylic frame 22 can be ordered from iBuyOfficeSupply.com/frames) and is placed on its back, providing an angled surface. The acrylic frame is pressed up against the stamp cam until it touches the cam at all points.

The acrylic picture frame provides a somewhat firm, yet giveable surface. If the surface is too firm, it will not give the stamp cam leeway to move, but it must be firm enough for the stamp to print on it. Because the frame is angled it can easily be adjusted by moving it forward or backward, until it just touches the cam.

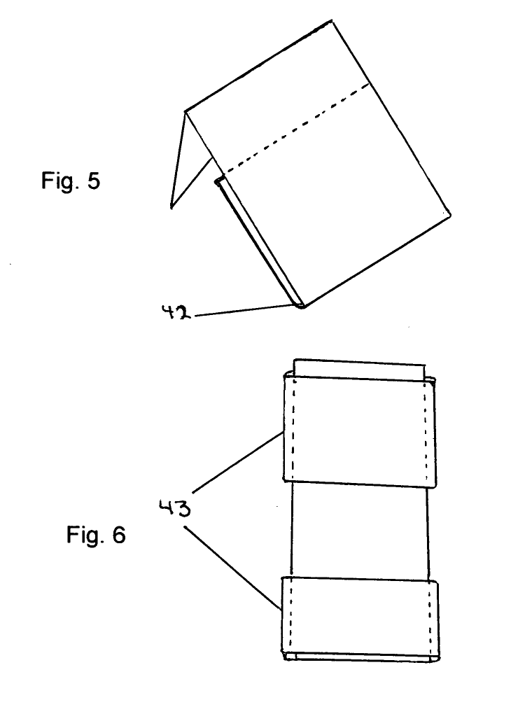

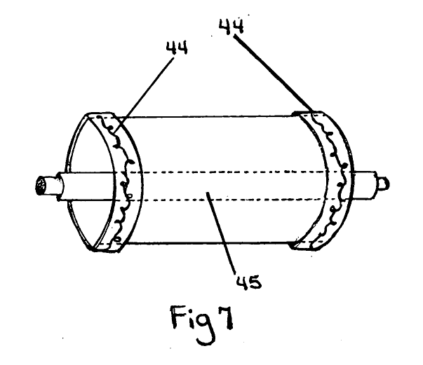

The frames usually have a turned end which keeps the photograph from falling out of the bottom. See FIGS. 5-42 I cut off the ends of the frames, and turn them sideways, and then glue them to the main frame at the front and the back so they provide a paper guide, 43 which keeps the paper from slipping to the sides, but still allow it to travel through the frame. See FIG. 6

Though I desire first to present this to the public in a manner that everyone could make and use it without purchasing additional parts, a lightweight and more expedient cam which could be manufactured is pictured in FIG. 7, with border stamps, 44, and center rod 45 already in place. This could be made to fit directly into the hole in the side of the press. The center would be covered with doublesided adhesive.

11. I claim as my own a rotating foam rubber inkpad, which inks an underlying stamp cam while simultaneously and continuously being refurbished with ink from an upper inking cam, leaking the refurbishing ink through perforations in the cam, the ink then passing through a porous foam sheet wrapped around the cam, (which tends to draw the ink out of the cam and spread it onto the inkpad;) the said inkpad then inking the underlying stamp cam, which in turn transfers the stamps image to the paper which is simultaneously being pulled through the stamp cam and acrylic frame support.

12. I reserve the right to reproduce this model, and any of its working parts in any size the public shows an interest in; as a larger model itself could accommodate larger documents and would be useful for journals, calendars, diaries, and the like, and different sized stamping cams would often be desirable, as would smaller holes in the inking cam which could better accommodate purchased inks, as would also different thicknesses and densities of sponges acclimate themselves better to specific inks; these all still adhering to the same basic design which is my own.

13. I also claim as my own this particular pattern for a press which can utilize any kind of ink, including pokeroot ink, and can be made by any individual fairly cheaply and easily, from easily available resources, without the pouring of molds, and which utilizes common parts which can be purchased from craft stores and hardware stores easily.
